(19) United States
(12) Patent Application Publication
(10) Pub. No.: US 2025/0036120 A1
(43) Pub. Date: Jan. 30, 2025

(54) Method, System, and Computer Program Product for Automatic Tweel Control in Molten Glass Manufacturing

(71) Applicant: Vitro Flat Glass LLC, Cheswick, PA (US)

(72) Inventors: Wei Xu, Cheswick, PA (US); Alan Dum, Pittsburgh, PA (US); Priyadarshi Mahapatra, Pittsburgh, PA (US); Russell W. Schrier, Oakmont, PA (US); Yu Jiao, Blawnox, PA (US)

(21) Appl. No.: 18/783,647

(22) Filed: Jul. 25, 2024

Related U.S. Application Data
(60) Provisional application No. 63/516,157, filed on Jul. 28, 2023.

(51) Int. Cl. G05B 23/02; C03B 5/24; G06T 7/13

(52) U.S. Cl. CPC G05B 23/0289; C03B 5/24; G05B 23/027; G05B 23/0275; G06T 7/13

(57) ABSTRACT

Systems, methods, and computer program products are provided for automatic tweel control in molten glass manufacturing. An example system includes a processor configured to receive visual data from a camera positioned with a view of a molten glass flow that is spreading from a melting tank into a bath containing molten metal, wherein a flow rate of the molten glass flow is controlled by a tweel. The processor is also configured to process the visual data to determine a value of a dimension of the molten glass flow. The processor is further configured to, in response to the value of the dimension of the molten glass flow satisfying a predetermined threshold value, generate a first control pulse signal to the tweel, wherein the first control pulse signal is configured to incrementally increase or decrease the flow rate of the molten glass flow.

### CROSS REFERENCE TO RELATED APPLICATION

This application claims priority to U.S. Provisional Patent Application No. 63/516,157, titled “Method, System, and Computer Program Product for Automatic Tweel Control in Molten Glass Manufacturing”, filed Jul. 28, 2023, the disclosure of which is hereby incorporated by reference in its entirety.

### BACKGROUND

### 1. Technical Field

This disclosure relates generally to glass manufacturing and, in non-limiting embodiments or aspects, to methods, systems, and computer program products for automatic tweel control in glass manufacturing.

### 2. Technical Considerations

Glass manufacturing may involve melting a glass composition and causing the molten glass to flow onto a bath of molten metal, where the molten glass spreads into a long plane atop the molten metal, so that the molten glass can be manipulated, cooled and transported to later steps in the glass manufacturing. In certain techniques, the glass batch and cullet is melted in a glass melting furnace and is released into a bath containing the molten metal via a pouring channel. In such techniques, a movable tweel (e.g., an insulated closure that can be opened and closed) may be mounted between the exit of the melting furnace and the entrance of the bath containing the molten metal. In certain techniques, control of the tweel is done by hand and is often subject to error. Common errors include opening the tweel too wide or leaving the tweel in a more open position too long, which allows too much molten glass to escape the furnace and flow onto the molten metal, which may cause the floating layer of molten glass to become too wide. Other errors include not opening the tweel wide enough or keeping the tweel in a more closed position too long, which prevents sufficient molten glass from leaving the furnace, which may cause the floating layer of molten glass to be too narrow.

There is a need in the art for a technical solution that provides automatic tweel control based on electronic detection of a state of the glass flow, and which further adjusts the movement of the tweel in a measured and controlled manner, so as to reduce or eliminate errors in tweel control.

### SUMMARY

According to some non-limiting embodiments or aspects, provided are methods, systems, and computer program products for automatic tweel control in molten glass manufacturing that overcome some or all of the deficiencies identified above.

According to some non-limiting embodiments or aspects, provided is a computer-implemented method for automatic tweel control in molten glass manufacturing. The computer-implemented method includes receiving, with at least one processor, visual data from at least one camera positioned with a view of a molten glass flow that is spreading from a melting tank into a bath containing molten metal, wherein a flow rate of the molten glass flow is controlled by a tweel associated with the bath. The method also includes processing, with at least one processor, the visual data to determine a value of at least one dimension of the molten glass flow. The method further includes, in response to the value of the at least one dimension of the molten glass flow satisfying at least one predetermined threshold value, generating, with at least one processor, at least one first control pulse signal to the tweel, wherein the at least one first control pulse signal is configured to incrementally increase or decrease the flow rate of the molten glass flow.

In some non-limiting embodiments or aspects, the method may include repeatedly executing, with at least one processor, for a duration of a glass manufacturing float line process: receiving new visual data from the at least one camera, processing the new visual data to determine a new value of the at least one dimension of the molten glass flow, and, in response to the new value of the at least one dimension of the molten glass flow satisfying the at least one predetermined threshold value, generating, with at least one processor, a new control pulse signal to the tweel, wherein the new control pulse signal is configured to incrementally increase or decrease the flow rate of the molten glass flow.

In some non-limiting embodiments or aspects, the method may include, before processing the visual data to determine the value of the at least one dimension of the molten glass flow, determining, with at least one processor, a heat output of a heat source associated with the melting tank, and adjusting, with at least one processor, at least one parameter of the visual data based on the heat output of the heat source, the at least one parameter selected from the group of: exposure; gain; and position.

In some non-limiting embodiments or aspects, the method may include detecting, with at least one processor, a process anomaly based at least partly on the processing of the visual data. The method may also include, in response to detecting the process anomaly, activating, with at least one processor, an alarm to signal to an operator to respond to the process anomaly.

In some non-limiting embodiments or aspects, the process anomaly may include a presence of debris in a manufacturing area containing the molten glass flow. Detecting the process anomaly based at least partly on the processing of the visual data may include detecting, with at least one processor, the presence of the debris in a field of view of the at least one camera during the processing of the visual data.

In some non-limiting embodiments or aspects, the process anomaly may include an equipment failure. Detecting the process anomaly based at least partly on the processing of the visual data may include comparing the value of the at least one dimension of the molten glass flow to at least one expected value of the molten glass flow, wherein the at least one expected value of the molten glass flow is associated with a prior control pulse signal sent to the tweel, and detecting the equipment failure based on a difference between the value of the at least one dimension of the molten glass flow and the at least one expected value of the molten glass flow.

In some non-limiting embodiments or aspects, the method may include, in response to detecting the equipment failure, changing a control mode of the tweel from an automatic mode to a semi-automatic mode or a manual mode.

In some non-limiting embodiments or aspects, the at least one dimension may be a maximum width of the molten glass flow. Processing the visual data to determine the value of at least one dimension of the molten glass flow may include converting the visual data from color to grayscale, executing an edge detection process to identify a first edge of the molten glass flow and a second edge of the molten glass flow from the visual data, wherein the first edge is opposite the second edge, and calculating the maximum width between the first edge and the second edge.

In some non-limiting embodiments or aspects, executing the edge detection process may further include receiving an input of at least one user-defined search line, and procedurally searching along the at least one user-defined search line until the first edge and the second edge are identified.

In some non-limiting embodiments or aspects, the method may further include determining a length of the at least one first control pulse signal that is generated based on a difference between the value of the at least one dimension of the molten glass flow and the at least one predetermined threshold value.

In some non-limiting embodiments or aspects, the method may further include determining a number of pulse signals of the at least one first control pulse signal that are generated based on a difference between the value of the at least one dimension of the molten glass flow and the at least one predetermined threshold value.

According to some non-limiting embodiments or aspects, provided is a system for automatic tweel control in molten glass manufacturing. The system includes at least one processor that is configured to receive visual data from at least one camera positioned with a view of a molten glass flow that is spreading from a melting tank into a bath containing molten metal, wherein a flow rate of the molten glass flow is controlled by a tweel associated with the bath. The at least one processor is also configured to process the visual data to determine a value of at least one dimension of the molten glass flow. The at least one processor is further configured to, in response to the value of the at least one dimension of the molten glass flow satisfying at least one predetermined threshold value, generate at least one first control pulse signal to the tweel, wherein the at least one first control pulse signal is configured to incrementally increase or decrease the flow rate of the molten glass flow.

In some non-limiting embodiments or aspects, the at least one processor may be further configured to repeatedly execute for a duration of a glass manufacturing float line process: receive new visual data from the at least one camera, process the new visual data to determine a new value of the at least one dimension of the molten glass flow, and, in response to the new value of the at least one dimension of the molten glass flow satisfying the at least one predetermined threshold value, generate a new control pulse signal to the tweel, wherein the new control pulse signal is configured to incrementally increase or decrease the flow rate of the molten glass flow.

In some non-limiting embodiments or aspects, the at least one dimension may be a maximum width of the molten glass flow. When processing the visual data to determine the value of at least one dimension of the molten glass flow, the at least one processor may be configured to convert the visual data from color to grayscale, execute an edge detection process to identify a first edge of the molten glass flow and a second edge of the molten glass flow from the visual data, wherein the first edge is opposite the second edge, and calculate the maximum width between the first edge and the second edge.

In some non-limiting embodiments or aspects, the at least one processor may be further configured to determine a length of the at least one first control pulse signal that is generated based on a difference between the value of the at least one dimension of the molten glass flow and the at least one predetermined threshold value.

In some non-limiting embodiments or aspects, the at least one processor may be further configured to determine a number of pulse signals of the at least one first control pulse signal that are generated based on a difference between the value of the at least one dimension of the molten glass flow and the at least one predetermined threshold value.

According to some non-limiting embodiments or aspects, provided is a computer program product for automatic tweel control in molten glass manufacturing. The computer program product includes at least one non-transitory computer-readable medium including program instructions that, when executed by at least one processor, cause the at least one processor to receive visual data from at least one camera positioned with a view of a molten glass flow that is spreading from a melting tank into a bath containing molten metal, wherein a flow rate of the molten glass flow is controlled by a tweel associated with the bath. The program instructions also cause the at least one processor to process the visual data to determine a value of at least one dimension of the molten glass flow. The program instructions further cause the at least one processor to, in response to the value of the at least one dimension of the molten glass flow satisfying at least one predetermined threshold value, generate at least one first control pulse signal to the tweel, wherein the at least one first control pulse signal is configured to incrementally increase or decrease the flow rate of the molten glass flow.

In some non-limiting embodiments or aspects, the program instructions may further cause the at least one processor to repeatedly execute for a duration of a glass manufacturing float line process: receive new visual data from the at least one camera; process the new visual data to determine a new value of the at least one dimension of the molten glass flow; and, in response to the new value of the at least one dimension of the molten glass flow satisfying the at least one predetermined threshold value, generate a new control pulse signal to the tweel, wherein the new control pulse signal is configured to incrementally increase or decrease the flow rate of the molten glass flow.

In some non-limiting embodiments or aspects, the program instructions may further cause the at least one processor to determine a length of the at least one first control pulse signal that is generated based on a difference between the value of the at least one dimension of the molten glass flow and the at least one predetermined threshold value.

In some non-limiting embodiments or aspects, the program instructions may further cause the at least one processor to determine a number of pulse signals of the at least one first control pulse signal that are generated based on a difference between the value of the at least one dimension of the molten glass flow and the at least one predetermined threshold value.

Further non-limiting embodiments or aspects are set forth in the following numbered clauses:

Clause 1: A computer-implemented method comprising: receiving, with at least one processor, visual data from at least one camera positioned with a view of a molten glass flow that is spreading from a melting tank into a bath containing molten metal, wherein a flow rate of the molten glass flow is controlled by a tweel associated with the bath; processing, with at least one processor, the visual data to determine a value of at least one dimension of the molten glass flow; and, in response to the value of the at least one dimension of the molten glass flow satisfying at least one predetermined threshold value, generating, with at least one processor, at least one first control pulse signal to the tweel, wherein the at least one first control pulse signal is configured to incrementally increase or decrease the flow rate of the molten glass flow.

Clause 2: The computer-implemented method of clause 1, further comprising repeatedly executing, with at least one processor, for a duration of a glass manufacturing float line process: receiving new visual data from the at least one camera; processing the new visual data to determine a new value of the at least one dimension of the molten glass flow; and, in response to the new value of the at least one dimension of the molten glass flow satisfying the at least one predetermined threshold value, generating, with at least one processor, a new control pulse signal to the tweel, wherein the new control pulse signal is configured to incrementally increase or decrease the flow rate of the molten glass flow.

Clause 3: The computer-implemented method of clause 1 or clause 2, further comprising, before processing the visual data to determine the value of the at least one dimension of the molten glass flow: determining, with at least one processor, a heat output of a heat source associated with the melting tank; and adjusting, with at least one processor, at least one parameter of the visual data based on the heat output of the heat source, the at least one parameter selected from the group of: exposure; gain; and position.

Clause 4: The computer-implemented method of any of clauses 1-3, further comprising: detecting, with at least one processor, a process anomaly based at least partly on the processing of the visual data; and, in response to detecting the process anomaly, activating, with at least one processor, an alarm to signal to an operator to respond to the process anomaly.

Clause 5: The computer-implemented method of any of clauses 1-4, wherein the process anomaly comprises a presence of debris in a manufacturing area containing the molten glass flow, and wherein detecting the process anomaly based at least partly on the processing of the visual data comprises: detecting, with at least one processor, the presence of the debris in a field of view of the at least one camera during the processing of the visual data.

Clause 6: The computer-implemented method of any of clauses 1-5, wherein the process anomaly comprises an equipment failure, and wherein detecting the process anomaly based at least partly on the processing of the visual data comprises: comparing the value of the at least one dimension of the molten glass flow to at least one expected value of the molten glass flow, wherein the at least one expected value of the molten glass flow is associated with a prior control pulse signal sent to the tweel; and detecting the equipment failure based on a difference between the value of the at least one dimension of the molten glass flow and the at least one expected value of the molten glass flow.

Clause 7: The computer-implemented method of any of clauses 1-6, further comprising, in response to detecting the equipment failure, changing a control mode of the tweel from an automatic mode to a semi-automatic mode or a manual mode.

Clause 8: The computer-implemented method of any of clauses 1-7, wherein the at least one dimension is a maximum width of the molten glass flow, and wherein processing the visual data to determine the value of at least one dimension of the molten glass flow further comprises: converting the visual data from color to grayscale; executing an edge detection process to identify a first edge of the molten glass flow and a second edge of the molten glass flow from the visual data, wherein the first edge is opposite the second edge; and calculating the maximum width between the first edge and the second edge.

Clause 9: The computer-implemented method of any of clauses 1-8, wherein executing the edge detection process further comprises: receiving an input of at least one user-defined search line; and procedurally searching along the at least one user-defined search line until the first edge and the second edge are identified.

Clause 10: The computer-implemented method of any of clauses 1-9, further comprising determining a length of the at least one first control pulse signal that is generated based on a difference between the value of the at least one dimension of the molten glass flow and the at least one predetermined threshold value.

Clause 11: The computer-implemented method of any of clauses 1-10, further comprising determining a number of pulse signals of the at least one first control pulse signal that are generated based on a difference between the value of the at least one dimension of the molten glass flow and the at least one predetermined threshold value.

Clause 12: A system comprising: at least one processor configured to: receive visual data from at least one camera positioned with a view of a molten glass flow that is spreading from a melting tank into a bath containing molten metal, wherein a flow rate of the molten glass flow is controlled by a tweel associated with the bath; process the visual data to determine a value of at least one dimension of the molten glass flow; and, in response to the value of the at least one dimension of the molten glass flow satisfying at least one predetermined threshold value, generate at least one first control pulse signal to the tweel, wherein the at least one first control pulse signal is configured to incrementally increase or decrease the flow rate of the molten glass flow.

Clause 13: The system of clause 12, wherein the at least one processor is further configured to repeatedly execute for a duration of a glass manufacturing float line process: receive new visual data from the at least one camera; process the new visual data to determine a new value of the at least one dimension of the molten glass flow; and, in response to the new value of the at least one dimension of the molten glass flow satisfying the at least one predetermined threshold value, generate a new control pulse signal to the tweel, wherein the new control pulse signal is configured to incrementally increase or decrease the flow rate of the molten glass flow.

Clause 14: The system of clause 12 or clause 13, wherein the at least one dimension is a maximum width of the molten glass flow, and wherein, when processing the visual data to determine the value of at least one dimension of the molten glass flow, the at least one processor is configured to: convert the visual data from color to grayscale; execute an edge detection process to identify a first edge of the molten glass flow and a second edge of the molten glass flow from the visual data, wherein the first edge is opposite the second edge; and calculate the maximum width between the first edge and the second edge.

Clause 15: The system of any of clauses 12-14, wherein the at least one processor is further configured to determine a length of the at least one first control pulse signal that is generated based on a difference between the value of the at least one dimension of the molten glass flow and the at least one predetermined threshold value.

Clause 16: The system of any of clauses 12-15, wherein the at least one processor is further configured to determine a number of pulse signals of the at least one first control pulse signal that are generated based on a difference between the value of the at least one dimension of the molten glass flow and the at least one predetermined threshold value.

Clause 17: A computer program product comprising at least one non-transitory computer-readable medium including program instructions that, when executed by at least one processor, cause the at least one processor to: receive visual data from at least one camera positioned with a view of a molten glass flow that is spreading from a melting tank into a bath containing molten metal, wherein a flow rate of the molten glass flow is controlled by a tweel associated with the bath; process the visual data to determine a value of at least one dimension of the molten glass flow; and, in response to the value of the at least one dimension of the molten glass flow satisfying at least one predetermined threshold value, generate at least one first control pulse signal to the tweel, wherein the at least one first control pulse signal is configured to incrementally increase or decrease the flow rate of the molten glass flow.

Clause 18: The computer program product of clause 17, wherein the program instructions further cause the at least one processor to repeatedly execute for a duration of a glass manufacturing float line process: receive new visual data from the at least one camera; process the new visual data to determine a new value of the at least one dimension of the molten glass flow; and, in response to the new value of the at least one dimension of the molten glass flow satisfying the at least one predetermined threshold value, generate a new control pulse signal to the tweel, wherein the new control pulse signal is configured to incrementally increase or decrease the flow rate of the molten glass flow.

Clause 19: The computer program product of clause 17 or clause 18, wherein the program instructions further cause the at least one processor to determine a length of the at least one first control pulse signal that is generated based on a difference between the value of the at least one dimension of the molten glass flow and the at least one predetermined threshold value.

Clause 20: The computer program product of any of clauses 17-19, wherein the program instructions further cause the at least one processor to determine a number of pulse signals of the at least one first control pulse signal that are generated based on a difference between the value of the at least one dimension of the molten glass flow and the at least one predetermined threshold value.

These and other features and characteristics of the present disclosure, as well as the methods of operation and functions of the related elements of structures and the combination of parts and economics of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter.

### BRIEF DESCRIPTION OF THE DRAWINGS

Additional advantages and details are explained in greater detail below with reference to the non-limiting, exemplary embodiments that are illustrated in the accompanying schematic figures, in which:

FIG. 1 is a schematic diagram of a system for automatic tweel control in molten glass manufacturing, according to some non-limiting embodiments or aspects of the present disclosure;

FIG. 2 is a schematic diagram of example components of one or more devices of FIG. 1, according to some non-limiting embodiments or aspects of the present disclosure;

FIG. 3 is a flow diagram of a method for automatic tweel control in molten glass manufacturing, according to some non-limiting embodiments or aspects of the present disclosure;

FIG. 4 is a flow diagram of a method for automatic tweel control in molten glass manufacturing, according to some non-limiting embodiments or aspects of the present disclosure;

FIG. 5 is a schematic diagram of a system for automatic tweel control in molten glass manufacturing, according to some non-limiting embodiments or aspects of the present disclosure;

FIG. 6 is a schematic diagram of a system for automatic tweel control in molten glass manufacturing, according to some non-limiting embodiments or aspects of the present disclosure;

FIG. 7A is a graphical representation of adjusting a tweel setpoint through a first control pulse signal sequence, according to some non-limiting embodiments or aspects of the present disclosure;

FIG. 7B is a graphical representation of adjusting a tweel setpoint through a second control pulse signal sequence, according to some non-limiting embodiments or aspects of the present disclosure;

FIG. 7C is a graphical representation of adjusting a tweel setpoint through a third control pulse signal sequence, according to some non-limiting embodiments or aspects of the present disclosure; and

FIG. 7D is a graphical representation of adjusting a tweel setpoint through a fourth control pulse signal sequence, according to some non-limiting embodiments or aspects of the present disclosure.

### DETAILED DESCRIPTION

For purposes of the description hereinafter, the terms “end”, “upper”, “lower”, “right”, “left”, “vertical”, “horizontal”, “top”, “bottom”, “lateral”, “longitudinal,” and derivatives thereof shall relate to non-limiting embodiments or aspects as they are oriented in the drawing figures. However, it is to be understood that the present disclosure may assume various alternative variations and step sequences, except where expressly specified to the contrary. It is also to be understood that the specific devices and processes illustrated in the attached drawings, and described in the following specification, are simply exemplary non-limiting embodiments or aspects of the disclosed subject matter. Hence, specific dimensions and other physical characteristics related to the embodiments or aspects disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

Some non-limiting embodiments or aspects are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, and/or the like.

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the term “server” may refer to or include one or more computing devices that are operated by or facilitate communication and processing for multiple entities in a network environment, such as the internet, although it will be appreciated that communication may be facilitated over one or more public or private network environments and that various other arrangements are possible. Further, multiple computing devices (e.g., servers, mobile devices, etc.) directly or indirectly communicating in the network environment may constitute a “system.”

As used herein, the term “system” may refer to one or more computing devices or combinations of computing devices (e.g., processors, servers, client devices, software applications, components of such, and/or the like). Reference to “a device”, “a server,” “a processor,” and/or the like, as used herein, may refer to a previously recited device, server, and/or processor that is recited as performing a previous step or function, a different device, server, or processor, and/or a combination of devices, servers, servers, and/or processors. For example, as used in the specification and the claims, a first device, a first server, or a first processor that is recited as performing a first step or a first function may refer to the same or different device, server, or processor recited as performing a second step or a second function.

The methods, systems, and computer program products described herein provide numerous technical advantages in systems for molten glass manufacturing. First, by eliminating manual operator control, described systems and methods do not suffer from variations in experience and knowledge from operator to operator in non-automated techniques. Moreover, described systems and methods may reduce or eliminate error in tweel control by basing the control of the tweel on a measurable value of a dimension of the molten glass flow. Accordingly, described systems and methods result in a more stable bath throughput tonnage, a more stable overall bath operation, and savings in energy and materials (e.g., by preventing waste through incorrect releases of molten glass flow). In particular, by transmitting visual data from a camera positioned with a view of a molten glass flow to a control system, described systems and methods have the benefit of being able to control the tweel from anywhere, including from a remote control system not located at the site of the glass manufacturing. Furthermore, by processing the visual data to determine a value of at least one dimension of the molten glass flow, described systems and methods are more precise (e.g., using machine vision to detect edges and measure distances of dimensions of glass flow). Such processing also may account for visual distortion typically introduced by heat sources, countering the over-illumination that might affect an edge detection process.

In addition to the immediate benefit of more precise tweel control that is less susceptible to error and waste, described systems and methods provide the benefit of process anomaly detection, based on the processing of the visual data. When a control system processes the visual data to determine a value of a dimension of a molten glass flow, the control system may additionally detect process anomalies, such as debris or equipment failure. Automatic detection of process anomalies allows for the described systems and methods to improve the glass manufacturing process by reacting more quickly to anomalies (e.g., by generating alerts to operators or automatically switching operation modes to semi-automatic or manual modes until the process anomaly is resolved). Quicker reaction time for process anomalies further reduces material waste.

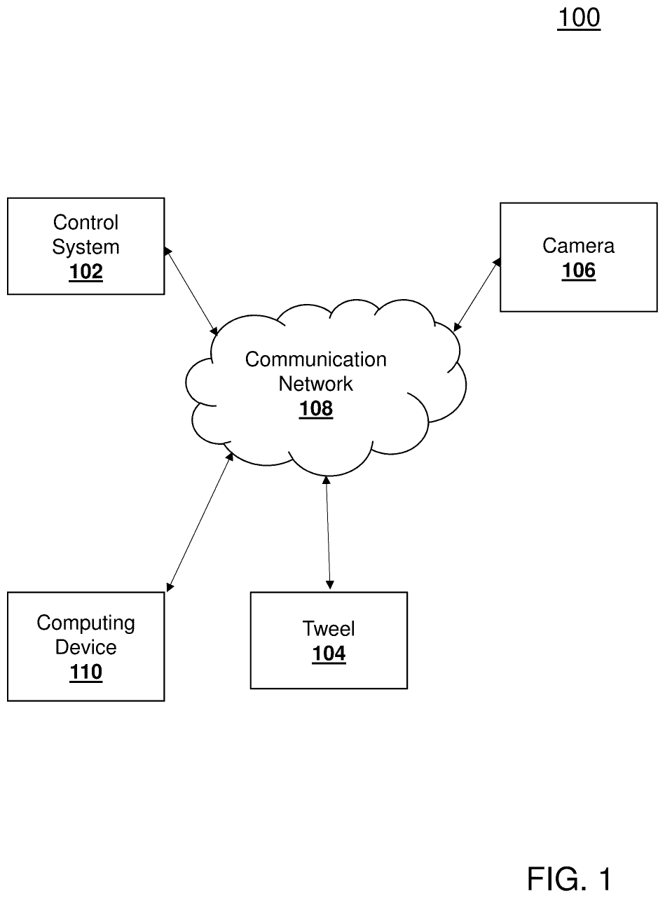

Referring now to FIG. 1, shown is a schematic diagram of an example system 100, according to some non-limiting embodiments or aspects. As shown in FIG. 1, system 100 may include control system 102, tweel 104, camera 106, and communication network 108. Control system 102, tweel 104, and camera 106 may interconnect (e.g., establish a connection to communicate) via wired connections, wireless connections, or a combination of wired and wireless connections.

Control system 102 may include one or more computing devices configured to communicate with tweel 104, camera 106, and/or computing device 110 at least partly over communication network 108. Control system 102 may be configured to monitor the operation of tweel 104 in system 100 and control tweel 104 to control the flow of molten glass for a manufacturing process. Control system 102 may include or be in communication with tweel 104 and/or camera 106. Control system 102 may be located on-site with the environment that includes the tweel 104, camera 106, melting tank, and bath, or may be positioned remotely from said environment.

Tweel 104 may include or be associated with one or more computing devices configured to communicate with control system 102, camera 106, and/or computing device 110 at least partly over communication network 108. Tweel 104 may be configured to open and close, to control the flow of molten glass metal in a manufacturing process. Tweel 104 may communicate with and/or be included in control system 102.

Camera 106 may include one or more processors that are configured to communicate with control system 102, tweel 104, and/or computing device 110 at least partly over communication network 108. Camera 106 may be configured to capture visual data (e.g., optical data that is visible (detectable) to the camera, which may or not be in the visual spectrum of a human viewer) of a molten glass manufacturing process. Camera 106 may communicate with and/or be included in control system 102. Camera 106 may include one or more cameras that are positioned with the same or different views of the melting tank, tweel 104, bath, and/or downstream process of the molten glass manufacturing process.

Computing device 110 may include one or more processors that are configured to communicate with control system 102, tweel 104, and/or camera 106 at least partly over communication network 108. Computing device 110 may be associated with a user that is monitoring the process for automatic tweel control. Computing device 110 may include a display for displaying one or more portions of visual data generated by camera 106. Computing device 110 may further include one or more input components (e.g., a mouse) to input user-defined search lines to guide control system's 102 processing of the visual data. Computing device 110 may be located on-site with the environment that includes the tweel 104, melting tank, camera 106, and bath, or may be positioned remotely from said environment.

Communication network 108 may include one or more wired and/or wireless networks over which the systems and devices of system 100 may communicate. For example, communication network 108 may include a cellular network (e.g., a long-term evolution (LTE®) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN)), a private network, an ad hoc network, an intranet, the Internet, a fiber optic-based network, a cloud computing network, and/or the like, and/or a combination of these or other types of networks.

The number and arrangement of systems and devices shown in FIG. 1 are provided as an example. There may be additional systems and/or devices, fewer systems and/or devices, different systems and/or devices, or differently arranged systems and/or devices than those shown in FIG. 1. Furthermore, two or more systems or devices shown in FIG. 1 may be implemented within a single system or device, or a single system or device shown in FIG. 1 may be implemented as multiple, distributed systems or devices. Additionally or alternatively, a set of systems (e.g., one or more systems) or a set of devices (e.g., one or more devices) of system 100 may perform one or more functions described as being performed by another set of systems or another set of devices of system 100.

In some non-limiting embodiments or aspects, control system 102 may perform one or more steps, independently or in conjunction with tweel 104 and one or more cameras 106, to provide a system for automatic tweel 104 control in molten glass manufacturing. For example, control system 102 may receive visual data (e.g., optical signals that may or may not be in the spectrum of human perception, and that may or may not be pre-processed) from at least one camera 106 positioned with a view (e.g., a detectable area) of a molten glass flow (e.g., heated to >1000° C.) that is spreading from a melting tank (e.g., a heated container, such as associated with a furnace) into a bath (e.g., an insulated container) containing molten metal (e.g., tin). Control system 102 may further process (e.g., filter, combine, convert, modify, transform, and/or analyze, etc.) the visual data to determine a value (e.g., a measurement, such as in pixels, inches, centimeters, degrees, or other quantitative measure) of at least one dimension of the molten glass flow (e.g., width of glass flow, length of glass flow, depth of glass flow, angle of spread of glass flow, spread rate of the glass flow, etc.).

With reference to determining the value of the at least one dimension of the molten glass flow, control system 102 may determine a number of image pixels in the visual data between an edge of the glass flow and a reference point (e.g., another edge of the glass, an edge of the bath, the same edge of the glass flow measured at a different time point, etc.) and converting the number of pixels to a distance unit based on an established calibration of camera 106. While physical dimensions may be determined from the visual data based on real measurements of the furnace and camera installation dimensions, it will be appreciated that non-physical dimension values may be used if an arbitrary reference value is provided.

With reference to processing, control system 102 may first modify one or more parameters of the visual data based on the environment of the melting tank and bath. For example, control system 102 may determine a heat output (e.g., British thermal units (BTUs), temperature, joules, etc.) of a heat source (e.g., one or more furnace elements) associated with the melting tank. Control system 102 may then adjust at least one parameter of the visual data based on the heat output of the heat source. The at least one parameter may include, but is not limited to, exposure (e.g., a representation of the amount of light that reaches camera's 106 sensor), gain (e.g., a representation of the relationship between the number of electrons acquired on an image sensor and the analog-to-digital units (ADUs) that are generated), and position (e.g., an area or location of a field of view). By way of further example, if the heat output of a heat source (e.g., for the melting tank, for the bath, etc.) is high, additional light may be produced in the view of camera 106, and so camera's 106 exposure may be lowered to account for the additional illumination. Modifications to the parameters of the visual data may be made at camera 106 before the visual data is generated, or may be made in the visual data itself after generation by camera 106.

With further reference to processing, control system 102 may use an edge detection process when processing the visual data. For example, control system 102 may convert the visual data from color to grayscale and execute an edge detection process (e.g., based on the intensity or shade of areas within visual data, such as where one subarea having a first shade abuts another subarea having a second shade). The edge detection process may identify a first edge of the molten glass flow and a second edge of the molten glass flow. Where the at least one dimension is a maximum width of the molten glass flow, the first edge may be opposite the second edge, on the sides of the molten glass flow, perpendicular to the direction of flow. Control system 102 may then calculate the maximum width between the first edge and the second edge, to determine the value of the at least one dimension of the molten glass flow. To further modify the edge detection process, control system 102 may receive an input of at least one user-defined search line (e.g., a path in the visual data along which control system 102 is directed to perform a search for an edge), such as from computing device 110 of a user. Control system 102 may procedurally search along the at least one user-defined search line until the first edge and the second edge are identified.

In some non-limiting embodiments or aspects, control system 102 may compare the value of the at least one dimension of the molten glass flow to at least one predetermined threshold value (e.g., a preset value for the measured dimension that is associated with an amount or flow rate of the molten glass flow, such as the glass flow being too little, too much, or expected). Control system 102 may, in response to the value of the at least one dimension of the molten glass flow satisfying at least one predetermined threshold value, generate at least one control pulse signal (e.g., one or more discrete transmissions of a signal configured to modify operation) to the tweel 104 (e.g., to control direction of movement, magnitude of movement, and/or the like). The control pulse signal may be configured to incrementally increase or decrease the flow rate of the molten glass flow, such as by causing the tweel 104 to incrementally open or close, respectively. For example, if the value of a dimension corresponding to width is less than a predetermined threshold value for a width of the glass flow, the at least one first control pulse signal may cause the tweel 104 to incrementally increase the flow rate of the molten glass flow.

In some non-limiting embodiments or aspects, control system 102 may perform the foregoing steps in a repeated process, for ongoing automatic control of the tweel 104. For example, control system 102 may repeatedly execute a series of steps to continue to monitor the glass flow and control the tweel 104. The series of steps may include receiving new visual data from the at least one camera 106, processing the new visual data to determine a new value of the at least one dimension of the molten glass flow, and, in response to the new value of the at least one dimension of the molten glass flow satisfying the at least one predetermined threshold value, generating a new control pulse signal to the tweel 104. The new control pulse signal may be configured to incrementally increase or decrease the flow rate of the molten glass flow. For example, if the new value of the dimension corresponding to width is greater than a predetermined threshold value for a width of the glass flow, the at least one new control pulse signal may cause the tweel 104 to incrementally decrease the flow rate of the molten glass flow. The above-described series of steps may be repeatedly executed for a time interval until control system 102 receives an instruction to stop the loop (e.g., from computing device 110 of a user).

With reference to control pulse signals, control system 102 may be configured to modify the length, number, and/or frequency of the control pulse signals. For example, control system 102 may determine a length (e.g., milliseconds) of the at least one first control pulse signal that is generated based on a difference between the value of the at least one dimension of the molten glass flow and the at least one predetermined threshold value. To illustrate, the greater the difference, the longer the at least one control pulse signal may be. Control system 102 may control each pulse signal in a plurality of control pulse signals to have the same length or different lengths. By way of further example, control system 102 may determine a number of pulse signals (e.g., being 1 or more) for the at least one first control pulse signal that are generated based on a difference between the value of the at least one dimension of the molten glass flow and the at least one predetermined threshold value. To illustrate, the greater the difference, the more control pulse signals may be generated.

In some non-limiting embodiments or aspects, control system 102 may perform other steps, beside automatic tweel control, based on the processing of the visual data. For example, control system 102 may detect a process anomaly (e.g., an abnormality in the expected and/or accepted manufacturing process) based at least partly on the processing of the visual data. In response to detecting the process anomaly, control system 102 may activate an alarm to signal to an operator to respond to (e.g., remove, address, etc.) the process anomaly. The alarm may be a visual, audible, and/or other sensory alarm that is associated with control system 102, tweel 104, camera 106, computing device 110, or another device in the environment, such as melting tank, bath, and/or the like. By way of further example, control system 102 may generate and communicate a message to computing device 110 configured to cause computing device 110 to generate a visual and/or auditory alert for a user. Additionally or alternatively, control system 102 may, in response to detecting the process anomaly (e.g., an equipment failure), change a control mode of tweel 104 from an automatic mode (e.g., in which control system 102 fully operates tweel 104) to a semi-automatic mode (e.g., in which control system 102 and a user operate tweel 104) or a manual mode (e.g., in which a user fully operates tweel 104).

With reference to detected anomalies, the detected process anomaly may be the presence of debris (e.g., one or more unexpected objects) in a manufacturing area containing the molten glass flow. Control system 102 may detect the presence of the debris in a field of view of camera 106 during the processing of the visual data (e.g., by detecting an object that is proximal to the camera 106, such as on the lens, or a shape of an object that is not expected by control system 102, and/or the like). The detected process anomaly may also be an equipment failure (e.g., a malfunction of one or more devices in the manufacturing area containing the molten glass flow). For example, control system 102 may compare the value of the at least one dimension of the molten glass flow to at least one expected value (e.g., comparing a measured width to an expected width). Control system 102 may then detect the equipment failure based on a difference between the value of the at least one dimension of the molten glass flow and at least one expected value (e.g., an expected value of the dimension based on a prior instruction sent to tweel 104 or an expected state of tweel 104). To illustrate, if tweel 104 was transmitted a prior control pulse signal to increase the flow rate of the glass flow, then the expected value of the width of the glass flow would be higher. However, if the measured value of the width is less than the expected value of the width by a significant difference (e.g., 5%, 10%, etc.), then control system 102 may infer that there is an equipment failure preventing tweel 104 from operating as instructed.

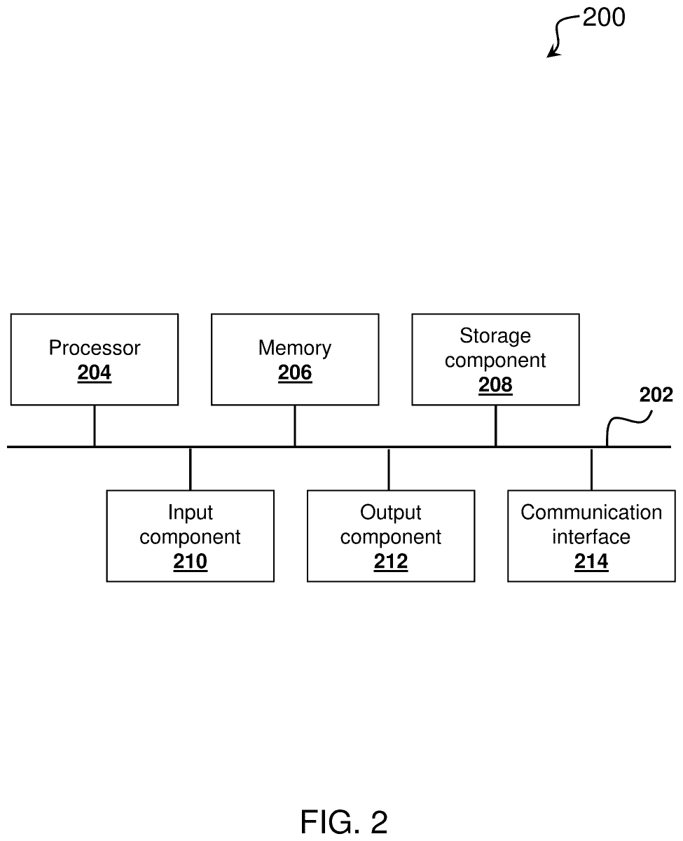

Referring now to FIG. 2, shown is a diagram of example components of a device 200, according to some non-limiting embodiments or aspects. Device 200 may correspond to control system 102, tweel 104, camera 106, and/or communication network 108, as an example. In some non-limiting embodiments or aspects, such systems or devices may include at least one device 200 and/or at least one component of device 200. The number and arrangement of components shown are provided as an example. In some non-limiting embodiments or aspects, device 200 may include additional components, fewer components, different components, or differently arranged components than those shown. Additionally, or alternatively, a set of components (e.g., one or more components) of device 200 may perform one or more functions described as being performed by another set of components of device 200.

As shown in FIG. 2, device 200 may include bus 202, processor 204, memory 206, storage component 208, input component 210, output component 212, and communication interface 214. Bus 202 may include a component that permits communication among the components of device 200. In some non-limiting embodiments or aspects, processor 204 may be implemented in hardware, firmware, or a combination of hardware and software. For example, processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 206 may include random access memory (RAM), read only memory (ROM), and/or another type of dynamic or static storage device (e.g., flash memory, magnetic memory, optical memory, etc.) that stores information and/or instructions for use by processor 204.

With continued reference to FIG. 2, storage component 208 may store information and/or software related to the operation and use of device 200. For example, storage component 208 may include a hard disk (e.g., a magnetic disk, an optical disk, a magneto-optic disk, a solid state disk, etc.) and/or another type of computer-readable medium. Input component 210 may include a component that permits device 200 to receive information, such as via user input (e.g., a touch screen display, a keyboard, a keypad, a mouse, a button, a switch, a microphone, etc.). Additionally, or alternatively, input component 210 may include a sensor for sensing information (e.g., a global positioning system (GPS) component, an accelerometer, a gyroscope, an actuator, etc.). Output component 212 may include a component that provides output information from device 200 (e.g., a display, a speaker, one or more light-emitting diodes (LEDs), etc.). Communication interface 214 may include a transceiver-like component (e.g., a transceiver, a separate receiver and transmitter, etc.) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium (e.g., a non-transitory computer-readable medium) is defined herein as a non-transitory memory device. A memory device includes memory space located inside of a single physical storage device or memory space spread across multiple physical storage devices. Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally, or alternatively, hardwired circuitry may be used in place of or in combination with software instructions to perform one or more processes described herein. Thus, embodiments or aspects described herein are not limited to any specific combination of hardware circuitry and software. The term “configured to”, as used herein, may refer to an arrangement of software, device(s), and/or hardware for performing and/or enabling one or more function (e.g., actions, processes, steps of a process, and/or the like). For example, “a processor configured to” may refer to a processor that executes software instructions (e.g., program code) that cause the processor to perform one or more functions.

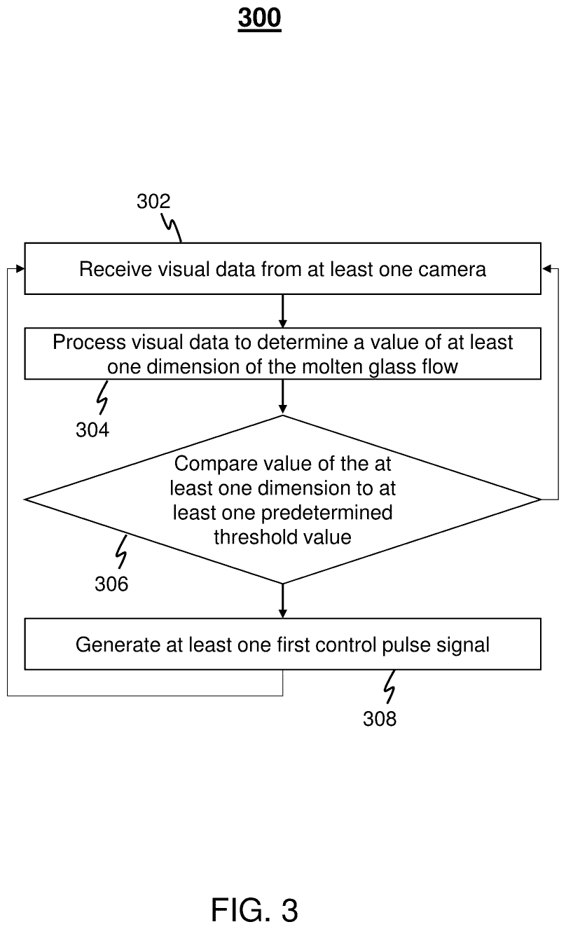

Referring now to FIG. 3, shown is a flow diagram of a method for automatic tweel control in molten glass manufacturing, according to some non-limiting embodiments or aspects of the present disclosure. The steps shown in FIG. 3 are for example purposes only. It will be appreciated that additional, fewer, different, and/or a different order of steps may be used in non-limiting embodiments or aspects. In some non-limiting embodiments or aspects, a step may be automatically performed in response to performance and/or completion of a prior step. In some non-limiting embodiments or aspects, one or more of the steps of process 300 may be performed (e.g., completely, partially, and/or the like) by control system 102. In some non-limiting embodiments or aspects, one or more of the steps of process 300 may be performed (e.g., completely, partially, and/or the like) by another system, another device, another group of systems, or another group of devices, separate from or including control system 102.

As shown in FIG. 3, at step 302, process 300 may include receiving visual data from at least one camera 106. For example, control system 102 may receive visual data from at least one camera 106 positioned with a view of a molten glass flow that is spreading from a melting tank into a bath containing molten metal. The flow rate of the molten glass flow may be controlled by a tweel 104 associated with the bath.

As shown in FIG. 3, at step 304, process 300 may include processing the visual data to determine a value of at least one dimension of the molten glass flow. For example, control system 102 may process the visual data to determine a value of at least one dimension of the molten glass flow.

In some non-limiting embodiments or aspects, the at least one dimension may be a maximum width of the molten glass flow. In such a case, processing the visual data to determine the value of the at least one dimension of the molten glass flow may include converting the visual data from color to grayscale, executing an edge detection process to identify a first and second edge of the molten glass flow (e.g., on opposite sides of the glass flow), and calculating the maximum width between the first edge and the second edge. Control system 102 may, in an edge detection process, receive an input of at least one user-defined search line from computing device 110 and procedurally search along the at least one user-defined search line until the first edge and the second edge are identified.

As shown in FIG. 3, at step 306, process 300 may include comparing the value of the at least one dimension to at least one predetermined threshold value. For example, control system 102 may compare the value of the at least one dimension to at least one predetermined threshold value. If the value of the at least one dimension satisfies the at least one predetermined threshold value, then process 300 may proceed to step 308. If the value of the at least one dimension does not satisfy the at least one predetermined threshold value, then process 300 may proceed back to step 302. The predetermined threshold value may be a singular value, in which case control system 102 may determine if the value of the at least one dimension substantially exceeds or is below the predetermined threshold value, in which case control system 102 may generate a first type of control pulse signal (e.g., to decrease flow rate) or a second type of control pulse signal (e.g., to increase flow rate). The predetermined threshold value may be two or more values. For example, one threshold value may be designated as an upper threshold, that if exceeded, a first type of control pulse signal is generated (e.g., to decrease flow rate), and a second threshold value may be designated as a lower threshold, that if passed below, a second type of control pulse signal is generated (e.g., to increase flow rate).

As shown in FIG. 3, at step 308, process 300 may include generating at least one first control pulse signal. For example, control system 102 may, in response to the value of the at least one dimension of the molten glass flow satisfying (e.g., meeting, falling below, or exceeding) at least one predetermined threshold value, generate at least one first control pulse signal to tweel 104. The at least one first control pulse signal may be configured to incrementally increase or decrease the flow rate of the molten glass flow.

In some non-limiting embodiments or aspects, control system 102 may determine a length of the at least one first control pulse signal that is generated based on a difference between the value of the at least one dimension of the molten glass flow and the at least one predetermined threshold value. In some non-limiting embodiments or aspects, control system 102 may determine a number of pulse signals of the at least one first control pulse signal that are generated based on a difference between the value of the at least one dimension of the molten glass flow and the at least one predetermined threshold value.

It will be appreciated that steps 302, 304, 306, and 308 may be executed repeatedly in a loop for a duration of a glass manufacturing float line process, or some time interval therein. For example, control system 102 may, at step 302, receive new visual data from the at least one camera 106. Control system 102 may, at step 304, process the new visual data to determine a new value of the at least one dimension of the molten glass flow. Control system 102 may, at step 306, compare the new value of the at least one dimension to at least one predetermined threshold value. Control system 102 may proceed back to step 302 and proceed again if the new value does not satisfy the predetermined threshold value. Control system 102 may, at step 308, and in response to the new value of the at least one dimension of the molten glass flow satisfying the at least one predetermined threshold value, generate a new control pulse signal to tweel 104, which is configured to incrementally increase the flow rate of the molten glass flow. Thereafter, process 300 may proceed back to step 302 and proceed again.

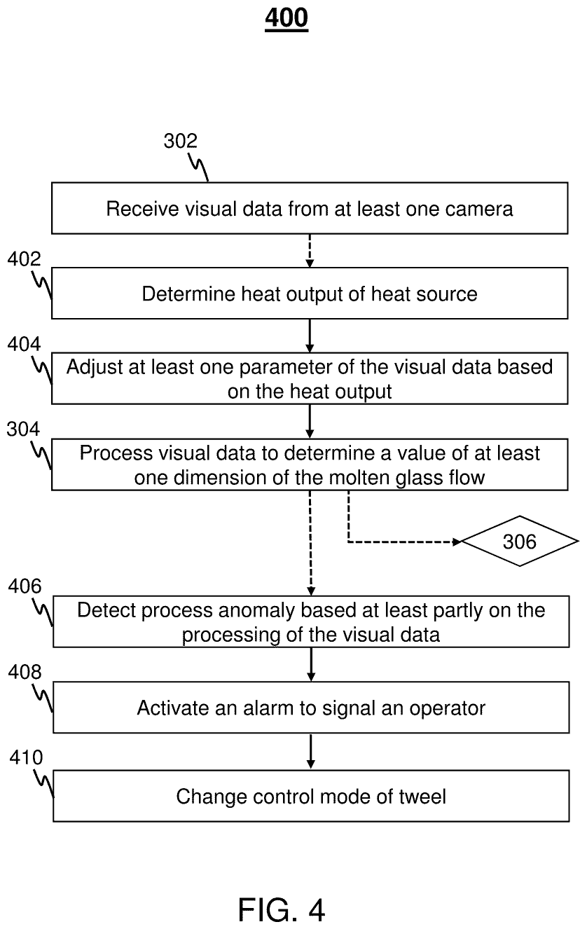

Referring now to FIG. 4, shown is a flow diagram of a method for automatic tweel control in molten glass manufacturing, according to some non-limiting embodiments or aspects of the present disclosure. The steps shown in FIG. 4 are for example purposes only. It will be appreciated that additional, fewer, different, and/or a different order of steps may be used in non-limiting embodiments or aspects. In some non-limiting embodiments or aspects, a step may be automatically performed in response to performance and/or completion of a prior step. In some non-limiting embodiments or aspects, one or more of the steps of process 400 may be performed (e.g., completely, partially, and/or the like) by control system 102. In some non-limiting embodiments or aspects, one or more of the steps of process 400 may be performed (e.g., completely, partially, and/or the like) by another system, another device, another group of systems, or another group of devices, separate from or including control system 102. Process 400 may be performed in addition to, and complimentary to, process 300.

As shown in FIG. 4, at step 302, process 400 may include receiving visual data from at least one camera 106. For example, control system 102 may receive visual data from at least one camera 106 positioned with a view of a molten glass flow that is spreading from a melting tank into a bath containing molten metal. The flow rate of the molten glass flow may be controlled by a tweel 104 associated with the bath.

As shown in FIG. 4, at step 402, process 400 may include determining a heat output of a heat source. For example, control system 102 may determine a heat output of a heat source associated with the melting tank.

As shown in FIG. 4, at step 404, process 400 may include adjusting at least one parameter of the visual data based on the heat output. For example, control system 102 may adjust at least one parameter of the visual data based on the heat output of the heat source. The at least one parameter may include, but is not limited to, exposure, gain, and position. One or more of the foregoing parameters may be adjusted based on the heat output, and the visual data may be adjusted directly (e.g., by modifying the data itself) or indirectly (e.g., by modifying a configuration of camera 106).

As shown in FIG. 4, at step 304, process 400 may include processing the visual data to determine a value of at least one dimension of the molten glass flow. For example, control system 102 may process the visual data to determine a value of at least one dimension of the molten glass flow. After adjusting the visual data in step 404 and processing the visual data in step 304, process 400 may proceed back to step 306, as shown in FIG. 3. Additionally or alternatively, process 400 may proceed to step 406, as shown in FIG. 4.

As shown in FIG. 4, at step 406, process 400 may include detecting a process anomaly based at least partly on the processing of the visual data. For example, control system 102 may detect a process anomaly based at least partly on the processing of the visual data. By way of further example, the process anomaly may be detected based on the visual data that is processed, or based on the quality of processing or inability to process the visual data. In the latter case, an issue with processing the visual data may be indicative of a process anomaly (e.g., equipment failure) with camera 106.

In some non-limiting embodiments or aspects, the process anomaly may include a presence of debris in a manufacturing area containing the molten glass flow. In such a case, detecting the process anomaly may include, at step 406, detecting the presence of debris in a field of view of at least one camera 106 during the processing of the visual data. In some non-limiting embodiments or aspects, the process anomaly may include an equipment failure. In such a case, detecting the process anomaly may include, at step 406, comparing the value of the at least one dimension of the molten glass flow to at least one expected value of the molten glass flow (e.g., wherein the at least one expected value of the molten glass flow is associated with a prior control pulse signal sent to tweel 104), and detecting the equipment failure based on a difference between the value of the at least one dimension of the molten glass flow and the at least one expected value of the molten glass flow.

As shown in FIG. 4, at step 408, process 400 may include activating an alarm to signal an operator. For example, control system 102 may, in response to detecting the process anomaly, activate an alarm to signal to an operator to respond to the process anomaly.

As shown in FIG. 4, at step 410, process 400 may include changing a control mode of the tweel 104. For example, control system 102 may, in response to detecting an equipment failure as a process anomaly, change a control mode of the tweel 104 from an automatic mode to a semi-automatic mode or a manual mode.

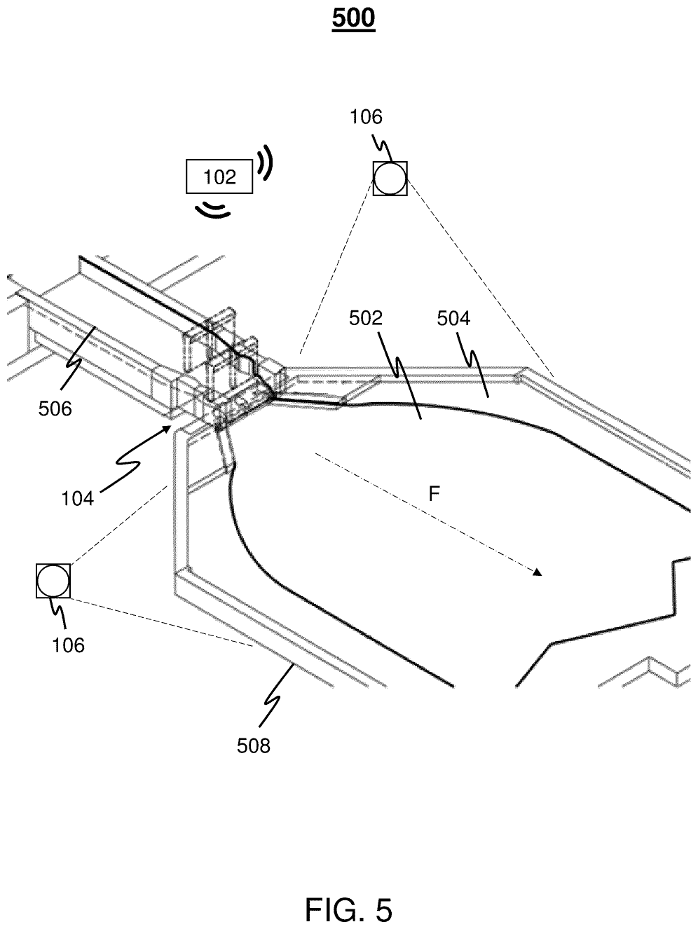

Referring now to FIG. 5, shown is a schematic diagram of a system 500 for automatic tweel control in molten glass manufacturing, according to some non-limiting embodiments or aspects of the present disclosure. The schematic diagram of FIG. 5 is a side-and-above perspective view of a glass manufacturing float line process. As shown, system 500 may include a bath 508 that contains molten metal 504 (e.g., tin). System 500 also includes melting tank 506, tweel 104, two or more cameras 106, and control system 102. Glass is melted in melting tank 506 and is released into bath 508 onto molten metal 504 as molten glass flow 502. Molten glass flow 502 is carried in the direction indicated by arrow F. Visual data is generated at each camera 106, and each camera 106 has a view of molten glass flow 502 that spreads from melting tank 506 into bath 508 (e.g., a view indicated by dashed lines emanating from the respective camera 106).

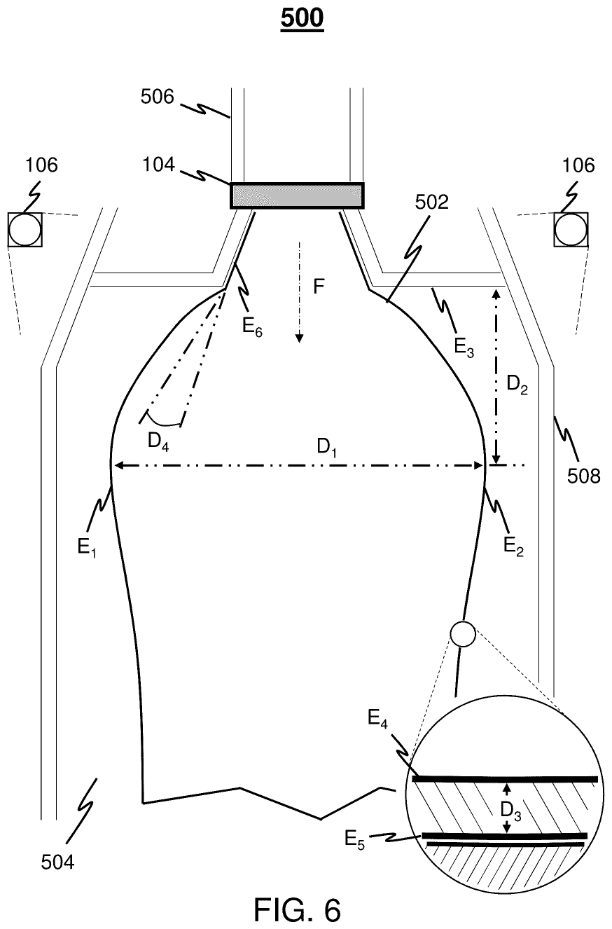

With further reference to FIG. 5, control system 102 is communicatively connected to each camera 106. Control system 102 may be positioned remotely from melting tank 506, tweel 104, bath 508, and cameras 106. Control system 102 may provide tweel 104 control for multiple molten glass manufacturing environments for a plurality of tweels 104 associated each with their own melting tank 506 and bath 508. Control system 102 may be communicatively connected to each camera 106 and may receive the visual data from each camera 106 corresponding to said camera's 106 view. Control system 102 may process the visual data from one or more cameras 106 in order to determine a value of at least one dimension of the molten glass flow 502. See FIG. 6 for further detailed discussion on one or more dimensions that may be determined for molten glass flow 502. It will be appreciated that control system 102 may use visual data from as few as one camera 106, if a single camera's 106 field of view captures visual data of a sufficient amount of molten glass flow 502 by which a dimension can be determined. Alternatively, control system 102 may use visual data from more than one camera 106 and use visual data from one or more cameras 106 to determine a dimension of molten glass flow 502. In using visual data from multiple cameras 106, control system 102 may combine the visual data from each camera 106 in the processing of the visual data.

With further reference to FIG. 5, control system 102 may compare the value of the at least one dimension of molten glass flow 502 to a predetermined threshold value. In response to the value of the at least one dimension of molten glass flow 502 satisfying the at least one predetermined threshold value, control system 102 may generate at least one first control pulse signal to tweel 104, to cause tweel 106 to incrementally increase or decrease the flow rate of molten glass flow 502 from melting tank 506 into bath 508. Control system 102 may further detect process anomalies based on the processing of the visual data and perform one or more steps in response to detection of a process anomaly, including activating an alarm, changing a control mode of tweel 104, and/or the like.

Referring now to FIG. 6, shown is a schematic diagram of a system 500 for automatic tweel 104 control in molten glass manufacturing, according to some non-limiting embodiments or aspects of the present disclosure. The schematic diagram of FIG. 6 is a top-down view of a glass manufacturing float line process and corresponds to the same system 500 as shown in FIG. 5. The illustrated area of the glass manufacturing float line process shown in FIG. 6 may be substantially captured in visual data by one or more cameras 106 (e.g., having a field of view indicated by the sector encompassed by vectors drawn in dashed lines). Cameras 106 may generate visual data of molten glass flow 502 on molten metal 504 in bath 508.

In some non-limiting embodiments or aspects, control system 102 may process the visual data to determine a value of one or more dimensions D₁, D₂, D₃, D₄ of molten glass flow 502. For example, control system 102 may process the visual data to determine a value of a first dimension D₁ associated with a width (e.g., a maximum width) of molten glass flow 502. To do so, control system 102 may use edge detection techniques to identify a first edge E₁ of molten glass flow 502 and a second edge E₂ of molten glass flow 502 from the visual data. As shown, first edge E₁ is opposite second edge E₂. Control system 102 may determine a distance between first edge E₁ and second edge E₂ to determine a value of first dimension D₁. When calculating a maximum width, control system 102 may identify an extremum on each edge E₁, E₂ of molten glass flow that is furthest from a center axis of molten glass flow 502 and calculate a distance between the extrema. Control system 102 may compare the value of first dimension D₁ to a predetermined threshold value and generate one or more control pulse signals to control tweel 104 to increase or decrease a flow rate of molten glass flow 502, as needed. For example, control system 102 may send one or more control pulse signals to tweel 104 to cause tweel 104 to increase the flow rate if the value of first dimension D₁ is less than (e.g., substantially less than) a predetermined threshold value for first dimension D₁. By way of further example, control system 102 may send one or more control pulse signals to tweel 104 to cause tweel 104 to decrease the flow rate if the value of first dimension D₁ is more than (e.g., substantially more than) a predetermined threshold value for first dimension D₁.

In some non-limiting embodiments or aspects, control system 102 may process the visual data to determine a value of a second dimension D₂ associated with a length (e.g., a length from top of bath 508 to apex of edge E₁, E₂) of molten glass flow 502. To do so, control system 102 may use edge detection techniques to identify an edge E₁, E₂ of molten glass flow 502 and an upper edge E₃ of bath 508 from the visual data. Control system 102 may determine a distance between a point on edge E₁, E₂ (e.g., an apex of edge E₁, E₂) of molten glass flow 502 to an upper edge E₃ of bath 508 to determine a value of second dimension D₂. Control system 102 may compare the value of second dimension D₂ to a predetermined threshold value and generate one or more control pulse signals to control tweel 104 to increase or decrease a flow rate of molten glass flow 502, as needed. For example, control system 102 may send one or more control pulse signals to tweel 104 to cause tweel 104 to increase the flow rate if the value of second dimension D₂ is greater than (e.g., substantially greater than) a predetermined threshold value for second dimension D₂. By way of further example, control system 102 may send one or more control pulse signals to tweel 104 to cause tweel 104 to decrease the flow rate if the value of second dimension D₂ is less than (e.g., substantially less than) a predetermined threshold value for second dimension D₂.

In some non-limiting embodiments or aspects, control system 102 may process the visual data to determine a value of a third dimension D₃ associated with a depth (e.g., a maximum depth) of molten glass flow 502. To do so, control system 102 may use edge detection techniques to identify an upper edge E₄ and a lower edge E₅ of molten glass flow 502 from the visual data. Control system 102 may determine a distance between a point on upper edge E₄ (e.g., a highest point of edge E₄) and a point on lower edge E₅ (e.g., a lowest point of edge E₅) to determine a value of third dimension D₃. Control system 102 may compare the value of third dimension D₃ to a predetermined threshold value and generate one or more control pulse signals to control tweel 104 to increase or decrease a flow rate of molten glass flow 502, as needed. For example, control system 102 may send one or more control pulse signals to tweel 104 to cause tweel 104 to increase the flow rate if the value of third dimension D₃ is less than (e.g., substantially less than) a predetermined threshold value for third dimension D₃. By way of further example, control system 102 may send one or more control pulse signals to tweel 104 to cause tweel 104 to decrease the flow rate if the value of third dimension D₃ is greater than (e.g., substantially greater than) a predetermined threshold value for third dimension D₃.

In some non-limiting embodiments or aspects, control system 102 may process the visual data to determine a value of a fourth dimension D₄ associated with an angle (e.g., an angle of spread) of molten glass flow 502. To do so, control system 102 may use edge detection techniques to identify an edge E₁ of molten glass flow 502 and an input edge E₆ of bath 508 (e.g., a wall of a pouring channel) from the visual data. Control system 102 may determine an angle between a point on edge E₁ (e.g., at a maximum width of molten glass flow 502) of molten glass flow 502 to an upper edge E₃ of bath 508, to determine a value of fourth dimension D₄. Control system 102 may compare the value of fourth dimension D₄ to a predetermined threshold value and generate one or more control pulse signals to control tweel 104 to increase or decrease a flow rate of molten glass flow 502, as needed. For example, control system 102 may send one or more control pulse signals to tweel 104 to cause tweel 104 to increase the flow rate if the value of fourth dimension D₄ is less than (e.g., substantially less than) a predetermined threshold value for fourth dimension D₄. By way of further example, control system 102 may send one or more control pulse signals to tweel 104 to cause tweel 104 to decrease the flow rate if the value of fourth dimension D₄ is greater than (e.g., substantially greater than) a predetermined threshold value for fourth dimension D₄.

In some non-limiting embodiments or aspects, control system 102 may compare one or more values for one or more dimensions D₁, D₂, D₃, D₄ to one or more predetermined threshold values for said dimensions D₁, D₂, D₃, D₄ to determine the type of control signal (e.g., increase or decrease flow rate), the length of control signal, and/or number of control signals to send to tweel 104.

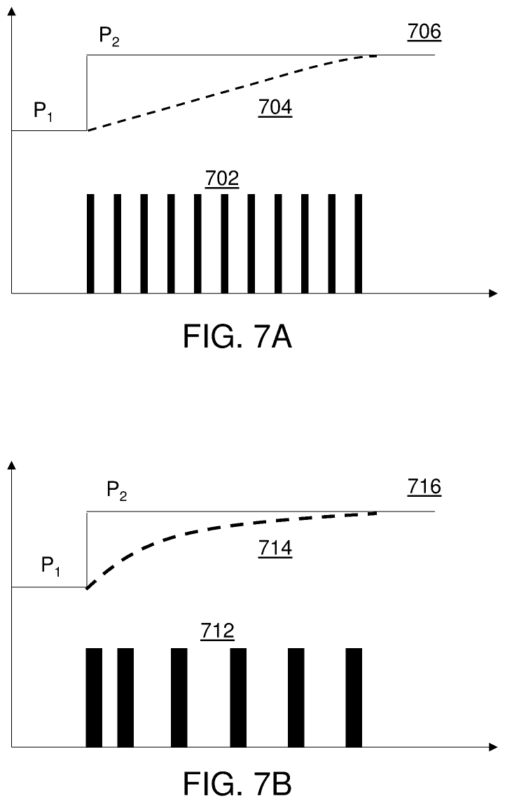

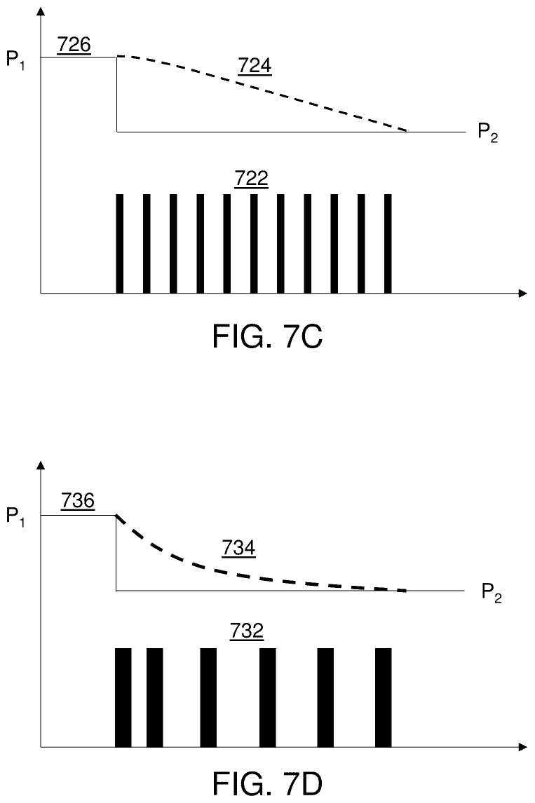

Referring now to FIGS. 7A-7D, shown are graphical representations of adjusting a tweel 104 setting through control pulse signal sequences 702, 712, 722, 732, according to non-limiting embodiments or aspects of the present disclosure. The x-axis of the graphs shown in FIGS. 7A-7D represents time, and the y-axis represents pulse/position (unitless). Each control pulse signal sequence 702, 712, 722, 732 is shown alongside a response plot 704, 714, 724, 734 of absolute encoder feedback representative of a response signal from tweel 104 indicating the actual position of tweel 104 (e.g., where a more closed position is lower on the y-axis, and a more open position is higher on the y-axis). Each control pulse signal sequence 702, 712, 722, 732 and response plot 704, 714, 724, 734 are also shown alongside a setpoint plot 706, 716, 726, 736 which shows the instructed setpoint (e.g., an intended position) for tweel 104 as determined by control system 102. Each response plot 704, 714, 724, 734 and setpoint plot 706, 716, 726, 736 share the same units and indicate the same measure of position for tweel 104, while each control pulse signal sequence 702, 712, 722, 732 is provided to show how a cotemporaneous set of pulse signals affect the actual position of tweel 104 (e.g., depicted by response plot 704, 714, 724, 734) relative to an intended position of tweel 104 (e.g., depicted by setpoint plot 706, 716, 726, 736).

With further reference to FIGS. 7A-7D, control system 102 may generate a control pulse signal sequence 702, 712, 722, 732 based on a comparison of a value of at least one dimension of a molten glass flow to a predetermined threshold value. The greater the difference between the measured value of the dimension and the predetermined threshold value, the greater may be the desired change in tweel 104 setpoint. Similarly, the greater the difference between the measured value of the dimension and the predetermined threshold value, the more rapid the rate of change may be in tweel 104 setpoint. For example, control system 102 may determine that a value of the at least one dimension falls below or above a predetermined threshold value by a first differential. Based on the magnitude of the first differential, control system 102 may determine a proportional magnitude of change from a first position P₁ of tweel 104 to a second position P₂ of tweel 104. This change in setpoint for tweel 104 is illustrated by the increase in the each setpoint plot 706, 716, 726, 736 from position P₁ to position P₂. Control system 102 may achieve an actual change in position of tweel 104 (shown in response plots 704, 714, 724, 734) by transmitting control pulse signal sequence 702, 712, 722, 732 to tweel 104. The movement of the tweel 104 may be split into a series of micro-movements caused by a series of pulse signals transmitted to the tweel 104 inverter or tweel 104 motor starter from control system 102. For purposes of illustration only, the movement of tweel 104 in response plots 704, 714, 724, 734 is shown as a smooth rate of change, but it will be appreciated that the actual movement in tweel 104 may not be smooth.

In some non-limiting embodiments or aspects, the length (e.g., width) of each pulse signal in control pulse signal sequence 702, 712, 722, 732 may be determined by the magnitude of change between P₁ and P₂ (e.g., longer individual pulses for a larger change), and/or the rate of change required (e.g., longer individual pulses for a more rapid change). For example, FIGS. 7B and 7D depicts longer individual pulses in second control pulse signal sequence 712 and fourth control pulse signal 732, compared to first control pulse signal sequence 702 of FIG. 7A and third control pulse signal sequence 722 of FIG. 7C; therefore, fewer individual pulses are required in second control pulse signal sequence 712 and fourth control pulse signal sequence 732 to achieve the same change in setpoint from position P₁ to position P₂, as compared to first control pulse signal sequence 702 and third control pulse signal sequence 722.

In some non-limiting embodiments or aspects, the length of control pulse signal sequence 702, 712, 722, 732 may be determined by the magnitude of change between P₁ and P₂ (e.g., longer transmission of pulses for a larger change). Each depicted control pulse signal sequence 702, 712, 722, 732 lasts for as long as is determined by control system 102 for tweel 104 to shift from position P₁ to position P₂.

In some non-limiting embodiments or aspects, the number of control pulse signals in first control pulse signal sequence 702 and third control pulse signal sequence 722 may be determined by the magnitude of change between P₁ and P₂ (e.g., more control pulse signals for a larger change), and/or the rate of change required (e.g., more control pulse signals for a more rapid change). For example, FIG. 7A and FIG. 7C depict more individual pulses in first control pulse signal sequence 702 and third control pulse signal sequence 722 compared to second control pulse signal sequence 712 of FIG. 7B and fourth control pulse signal sequence 732 of FIG. 7D. Because the individual pulse signals of first control pulse signal sequence 702 and third control pulse signal sequence 722 are shorter than the individual pulse signals of second control pulse signal sequence 712 and fourth control pulse signal sequence 732, first control pulse signal sequence 702 and third control pulse signal sequence 722 contain more pulse signals to effect the same change in tweel 104 setpoint from position P₁ to position P₂.

In some non-limiting embodiments or aspects, the spacing (e.g., interval, frequency, etc.) of control pulse signals in control pulse signal sequence 702, 712, 722, 732 may be determined by the magnitude of change between P₁ and P₂ (e.g., more frequent control pulse signals for a larger change), and/or the rate of change required (e.g., more frequent control pulse signals for a more rapid change). For example, FIG. 7A and FIG. 7C depict a first control pulse signal sequence 702 and third control pulse signal sequence 722 where each individual pulse signal is spaced equally within the first control pulse signal sequence 702 and third control pulse signal sequence 722, which results in a relatively steady rate of change in tweel's 104 actual position (response plot 704, 724) from setpoint position P₁ to position P₂. In contrast, FIG. 7B and FIG. 7D depict a second control pulse signal sequence 712 and fourth control pulse signal sequence 732 where the spacing between signal pulses is more frequent at the start of second control pulse signal sequence 712 and fourth control pulse signal sequence 732 and gradually tapers off. Second control pulse signal sequence 712 and fourth control pulse signal sequence 732 produce a curved rate of change in tweel's 104 actual position (response plot 714, 734) where the tweel 104 first responds quickly to change its position, but then gradually slows its rate of change until tweel 104 reaches setpoint position P₂.

With further reference to FIGS. 7A-7D, the automatic tweel control loop may be configured to adjust the tweel height in real-time. As used herein, “real-time” may refer to the capability of a system or process to receive, process, and respond to inputs or events within a timeframe that is imperceptible to the user or in accordance with the constraints of the application domain. In the context of glass manufacturing, real-time may denote the ability to perform data processing, analysis, decision-making, and mechanical control substantially within seconds or less, ensuring that the output is provided or the action is performed virtually immediately after the input is received, thus enabling timely and responsive operation. The automatic tweel control loop may adjust the tweel height in real-time to maintain the glass spread (e.g., “onion”) width in the bath of a float glass furnace at a given target value, so that a more stable bath throughput tonnage and process condition can be achieved. While the following may refer primarily to the dimension of width of the onion, it will be appreciated that other dimensions of the glass spread (e.g., angle of neck, thickness, etc.), discussed hereinabove, may be included, additionally or alternatively, for determining the rate or amount of glass being output from the tweel.

In some non-limiting embodiments or aspects, a tweel height controller of control system 102 may use an absolute encoder as the input of the control loop. The movement of the tweel in this control loop may be accomplished by sending a series of equal length and equally spaced pulses to the tweel inverter, tweel motor starter, and/or the like. Each pulse may move the tweel either up or down a pre-calibrated distance to a new height position. The direction and the number of pulses of the tweel movement may be determined by the deviation between the tweel height measurement and the onion width setpoint. Both the length and spacing of pulses may be tuned as required for the system.

In some non-limiting embodiments or aspects, the tweel height controller of control system 102 may be an incremental controller, where the new tweel height position may be calculated based on the previous tweel height added or subtracted by the new incremental tweel movement resulted from the pulse. Equations representing this calculation may be shown as follows:

$$Δ {T}_{wsp} ( t ) = {k}_{1} [ {k}_{c 1} Δ {O}_{b} ( t ) + {k}_{c 2} \frac{d Δ {O}_{b} ( t )}{dt} ] \qquad Formula 1$$

$$and$$

$${T}_{wsp} ( t ) = Δ {T}_{wsp} ( t ) + {T}_{w} ( t - 1 ) \qquad Formula 2$$

where ΔT_{wsp}(t) denotes the incremental change of the tweel height, ΔO_{b}(t) denotes the bath onion deviation, T_{w}(t−1) denotes the previous tweel height, k₁ denotes the unit conversion factor between the onion width change and tweel height move, k_{c1} denotes a multiplier for the proportional component, and k_{c2} is the multiplier for the derivative component of the onion width controller (e.g., the tweel height controller). ΔT_{wsp}(t) may then be compared to the high and low limits constrained by the hardware or the user. For example, if ΔTwsp(t) falls out of the range, it may be capped at the nearest limit. To account for the process response time of the onion width upon tweel moves, a delay timer logic may also be included in the controller to not accept the new T_{wsp}(t) until a pre-calibrated time period expires.

In some non-limiting embodiments or aspects, once the calculated new tweel height position is accepted by the tweel control logic, the new tweel height position's difference from the current tweel height position yields the required tweel move magnitude and direction, which may be checked against the predefined maximum and minimum tweel height deviation, so that the tweel height controller may be prevented from driving the tweel into the undesired condition. The tweel inverter, tweel motor starter, and/or the like may then be actuated in pulses to incrementally move the tweel to the determined new position.

In some non-limiting embodiments or aspects, real-time tonnage calculations may be determined by control system 102 using a tonnage calculator that computes the tonnage from measurements of the bath exit ribbon width, line speed, average thickness of the net ribbon, and a density coefficient. Based on the real-time tonnage measurement and the tonnage target, control system 102 may recommend a new bath onion setpoint if the deviation of the tonnage satisfies a predefined threshold.

In some non-limiting embodiments or aspects, to start the tweel control loop without unexpected process “bump”, an automatic mode initialization (AMI) algorithm may be used to ensure the tweel height controller always starts from the positions of the existing tweel height and the onion width, such that the control deviations of tweel height and onion width are equal to zero, and no immediate control actions will occur if the tweel height controller is just activated.

In some non-limiting embodiments or aspects, to ensure the automatic tonnage control loop operates under a fault-free condition, a system failure protection (SFP) system may be configured and operated to protect control system 102 in the following two areas: (i) control and instrument hardware malfunctions; and (ii) abnormal process behaviors. Under these conditions, the protection alarm may be triggered and the tweel height controller may be automatically turned to a manual mode. A manual control (e.g., a button) on the tweel height controller may be designated (e.g., with a blinking text display) to indicate that the controller mode was changed to a manual mode due to a detected alarm condition.

In some non-limiting embodiments or aspects, detectable control and instrument hardware malfunctions may include, but are not limited to: (i) connection to an onion measurement sensor is lost; (ii) raw measurements used to calculate a dimension of the onion is found to be of bad quality or unavailable; (iii) the difference between the filtered and unfiltered onion measurement data exceeds a certain threshold that indicates the onion dimension measurement is not reliable; (iv) the signals used to move the tweel up or down are found to be of bad quality or is not updating; (v) the recommended tweel height setpoint is detected to be of bad quality or is not updating; (vi) the tweel height measurement is found to be of bad quality or is not updating; (vii) the tweel movement requested has timed out for movement not completed with a defined time period; or (viii) detection that the automatic operation mode signal sent to the tweel inverter, tweel motor starter, and/or the like is of bad quality or unavailable, or the automatic/manual mode switch signal at the tweel height controller is of bad quality or unavailable.

In some non-limiting embodiments or aspects, detectable abnormal process behaviors may include, but are not limited to: (i) a step change in line speed or downstream top roll/assisted direct stretch machine movement is detected to be larger than the chosen limit; (ii) the current onion dimension is outside a certain range; (iii) the onion dimension changes more than a threshold within a predefined time span; (iv) the tweel height has reached its absolute high or low limit; (v) the difference between the tweel height setpoint and the current tweel position is greater than a predefined limit; or (vi) the tweel movement compared to the onion response over a selected time period is larger than a chosen threshold value.

Although embodiments have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect.

What is claimed is:

1. A computer-implemented method comprising:
receiving, with at least one processor, visual data from at least one camera positioned with a view of a molten glass flow that is spreading from a melting tank into a bath containing molten metal, wherein a flow rate of the molten glass flow is controlled by a tweel associated with the bath;
processing, with at least one processor, the visual data to determine a value of at least one dimension of the molten glass flow; and
in response to the value of the at least one dimension of the molten glass flow satisfying at least one predetermined threshold value, generating, with at least one processor, at least one first control pulse signal to the tweel, wherein the at least one first control pulse signal is configured to incrementally increase or decrease the flow rate of the molten glass flow.

2. The computer-implemented method of claim 1, further comprising repeatedly executing, with at least one processor, for a duration of a glass manufacturing float line process:
receiving new visual data from the at least one camera;
processing the new visual data to determine a new value of the at least one dimension of the molten glass flow; and
in response to the new value of the at least one dimension of the molten glass flow satisfying the at least one predetermined threshold value, generating, with at least one processor, a new control pulse signal to the tweel, wherein the new control pulse signal is configured to incrementally increase or decrease the flow rate of the molten glass flow.

3. The computer-implemented method of claim 1, further comprising, before processing the visual data to determine the value of the at least one dimension of the molten glass flow:
determining, with at least one processor, a heat output of a heat source associated with the melting tank; and
adjusting, with at least one processor, at least one parameter of the visual data based on the heat output of the heat source, the at least one parameter selected from the group of: exposure; gain; and position.

4. The computer-implemented method of claim 1, further comprising:
detecting, with at least one processor, a process anomaly based at least partly on the processing of the visual data; and
in response to detecting the process anomaly, activating, with at least one processor, an alarm to signal to an operator to respond to the process anomaly.

5. The computer-implemented method of claim 4, wherein the process anomaly comprises a presence of debris in a manufacturing area containing the molten glass flow, and wherein detecting the process anomaly based at least partly on the processing of the visual data comprises:
detecting, with at least one processor, the presence of the debris in a field of view of the at least one camera during the processing of the visual data.

6. The computer-implemented method of claim 4, wherein the process anomaly comprises an equipment failure, and wherein detecting the process anomaly based at least partly on the processing of the visual data comprises:
comparing the value of the at least one dimension of the molten glass flow to at least one expected value of the molten glass flow, wherein the at least one expected value of the molten glass flow is associated with a prior control pulse signal sent to the tweel; and
detecting the equipment failure based on a difference between the value of the at least one dimension of the molten glass flow and the at least one expected value of the molten glass flow.

7. The computer-implemented method of claim 6, further comprising, in response to detecting the equipment failure, changing a control mode of the tweel from an automatic mode to a semi-automatic mode or a manual mode.

8. The computer-implemented method of claim 1, wherein the at least one dimension is a maximum width of the molten glass flow, and wherein processing the visual data to determine the value of at least one dimension of the molten glass flow further comprises:
converting the visual data from color to grayscale;
executing an edge detection process to identify a first edge of the molten glass flow and a second edge of the molten glass flow from the visual data, wherein the first edge is opposite the second edge; and
calculating the maximum width between the first edge and the second edge.

9. The computer-implemented method of claim 8, wherein executing the edge detection process further comprises:
receiving an input of at least one user-defined search line; and
procedurally searching along the at least one user-defined search line until the first edge and the second edge are identified.

10. The computer-implemented method of claim 1, further comprising determining a length of the at least one first control pulse signal that is generated based on a difference between the value of the at least one dimension of the molten glass flow and the at least one predetermined threshold value.

11. The computer-implemented method of claim 1, further comprising determining a number of pulse signals of the at least one first control pulse signal that are generated based on a difference between the value of the at least one dimension of the molten glass flow and the at least one predetermined threshold value.

12. A system comprising:
at least one processor configured to:
receive visual data from at least one camera positioned with a view of a molten glass flow that is spreading from a melting tank into a bath containing molten metal, wherein a flow rate of the molten glass flow is controlled by a tweel associated with the bath;
process the visual data to determine a value of at least one dimension of the molten glass flow; and
in response to the value of the at least one dimension of the molten glass flow satisfying at least one predetermined threshold value, generate at least one first control pulse signal to the tweel, wherein the at least one first control pulse signal is configured to incrementally increase or decrease the flow rate of the molten glass flow.

13. The system of claim 12, wherein the at least one processor is further configured to repeatedly execute for a duration of a glass manufacturing float line process:
receive new visual data from the at least one camera;
process the new visual data to determine a new value of the at least one dimension of the molten glass flow; and
in response to the new value of the at least one dimension of the molten glass flow satisfying the at least one predetermined threshold value, generate a new control pulse signal to the tweel, wherein the new control pulse signal is configured to incrementally increase or decrease the flow rate of the molten glass flow.

14. The system of claim 12, wherein the at least one dimension is a maximum width of the molten glass flow, and wherein, when processing the visual data to determine the value of at least one dimension of the molten glass flow, the at least one processor is configured to:
convert the visual data from color to grayscale;
execute an edge detection process to identify a first edge of the molten glass flow and a second edge of the molten glass flow from the visual data, wherein the first edge is opposite the second edge; and
calculate the maximum width between the first edge and the second edge.

15. The system of claim 12, wherein the at least one processor is further configured to determine a length of the at least one first control pulse signal that is generated based on a difference between the value of the at least one dimension of the molten glass flow and the at least one predetermined threshold value.

16. The system of claim 12, wherein the at least one processor is further configured to determine a number of pulse signals of the at least one first control pulse signal that are generated based on a difference between the value of the at least one dimension of the molten glass flow and the at least one predetermined threshold value.

17. A computer program product comprising at least one non-transitory computer-readable medium including program instructions that, when executed by at least one processor, cause the at least one processor to:
receive visual data from at least one camera positioned with a view of a molten glass flow that is spreading from a melting tank into a bath containing molten metal, wherein a flow rate of the molten glass flow is controlled by a tweel associated with the bath;
process the visual data to determine a value of at least one dimension of the molten glass flow; and
in response to the value of the at least one dimension of the molten glass flow satisfying at least one predetermined threshold value, generate at least one first control pulse signal to the tweel, wherein the at least one first control pulse signal is configured to incrementally increase or decrease the flow rate of the molten glass flow.

18. The computer program product of claim 17, wherein the program instructions further cause the at least one processor to repeatedly execute for a duration of a glass manufacturing float line process:
receive new visual data from the at least one camera;
process the new visual data to determine a new value of the at least one dimension of the molten glass flow; and
in response to the new value of the at least one dimension of the molten glass flow satisfying the at least one predetermined threshold value, generate a new control pulse signal to the tweel, wherein the new control pulse signal is configured to incrementally increase or decrease the flow rate of the molten glass flow.

19. The computer program product of claim 17, wherein the program instructions further cause the at least one processor to determine a length of the at least one first control pulse signal that is generated based on a difference between the value of the at least one dimension of the molten glass flow and the at least one predetermined threshold value.

20. The computer program product of claim 17, wherein the program instructions further cause the at least one processor to determine a number of pulse signals of the at least one first control pulse signal that are generated based on a difference between the value of the at least one dimension of the molten glass flow and the at least one predetermined threshold value.
